(19) United States
(12) Patent Application Publication
(10) Pub. No.: US 2012/0139278 A1
(43) Pub. Date: Jun. 7, 2012

(54) FLEXIBLE ADJUSTABLE GRIPPING DEVICE

(75) Inventors: YONG XIE, Shenzhen City (CN); XIAO-BIN WU, Shenzhen City (CN); BING LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/167,975

(22) Filed: Jun. 24, 2011

(30) Foreign Application Priority Data
Dec. 4, 2010 (CN) 201010573282.6

(51) Int. Cl. B25J 15/00; B25J 15/02

(52) U.S. Cl. 294/207

(57) ABSTRACT

A flexible adjustable gripping device includes a gripping jaw assembly and a flexible adjusting mechanism. The flexible adjusting mechanism includes a flexible adjusting base, a sliding block and a sliding shaft. The flexible adjusting base defines a mounting slot. The sliding block is slidably assembled within the mounting slot, and slidably connected with the sliding shaft. The gripping jaw assembly is fixed with the sliding shaft. The flexible adjustable gripping device has a simple structure and is easily operate.

### BACKGROUND

1. Technical Field

This disclosure relates to gripping devices, and particularly, to a flexible adjustable gripping device.

2. Description of Related Art

Flexible adjustable gripping devices are widely applied to industrial robots for gripping workpieces automatically. However, a commonly used flexible adjustable gripping device has a complex structure and low accuracy for gripping the workpieces automatically. In addition, the commonly used flexible adjustable gripping device cannot align with a central portion of a pre-gripped workpiece automatically and accurately.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings like reference numerals designate corresponding parts throughout the several views. Wherever possible, the same reference numerals are used throughout the drawings to refer to the same or like elements of an embodiment.

FIG. 1 is an assembled, isometric view of an embodiment of a flexible adjustable gripping device.

FIG. 2 is an exploded, isometric view of the flexible adjustable gripping device of FIG. 1.

FIG. 3 is similar to FIG. 2, but viewed from another aspect.

FIG. 4 is a cross-section of the flexible adjustable gripping device of FIG. 1.

### DETAILED DESCRIPTION

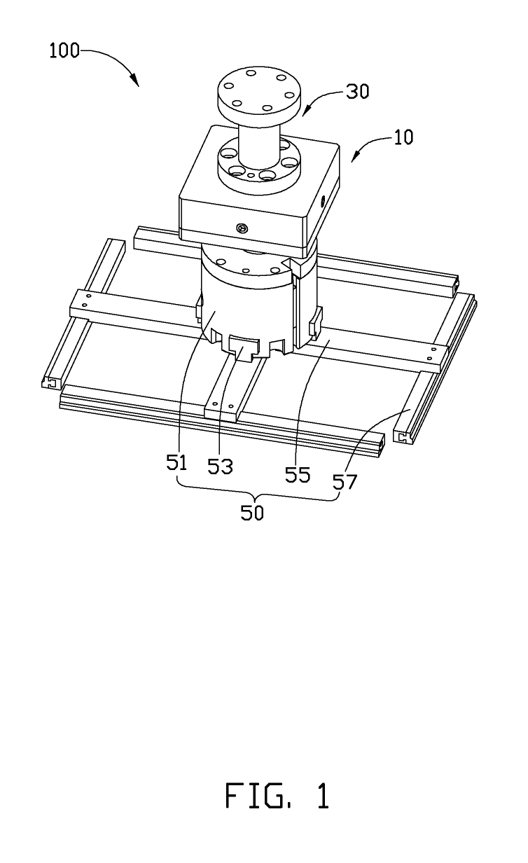

Referring to FIG. 1, an embodiment of a flexible adjustable gripping device 100 is shown. The flexible adjustable gripping device 100 includes a flexible adjusting mechanism 10, a connecting member 30 and a gripping jaw assembly 50. A first end of the connecting member 30 is fixed to the flexible adjusting mechanism 10, and a second end of the connecting member 30 opposite to the first end of the connecting member 30 is connected to a mechanical arm or a driving shaft of a robot (not shown). The gripping jaw assembly 50 is mounted to one end of the flexible adjusting mechanism 10 opposite to the connecting member 30, for gripping a workpiece (not shown).

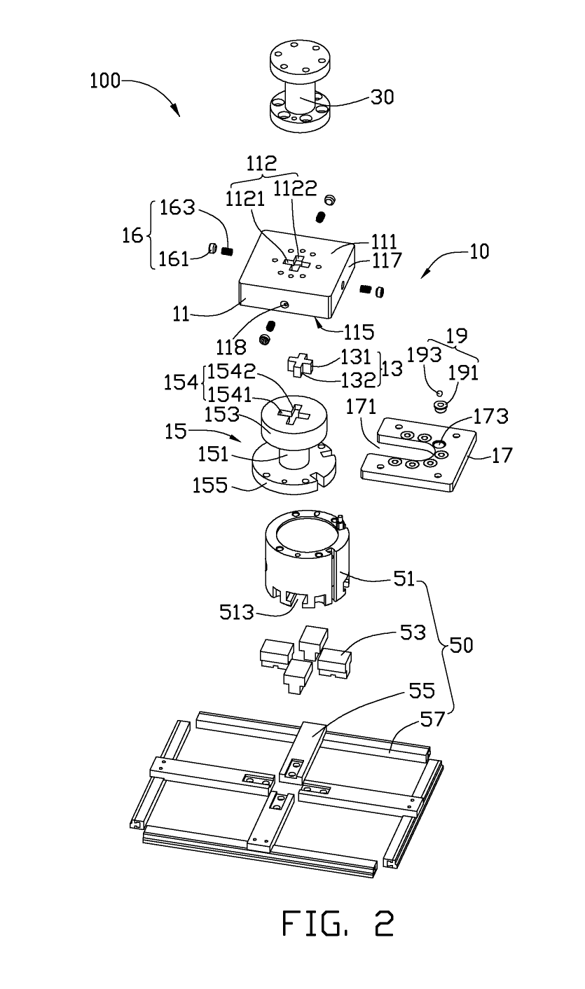

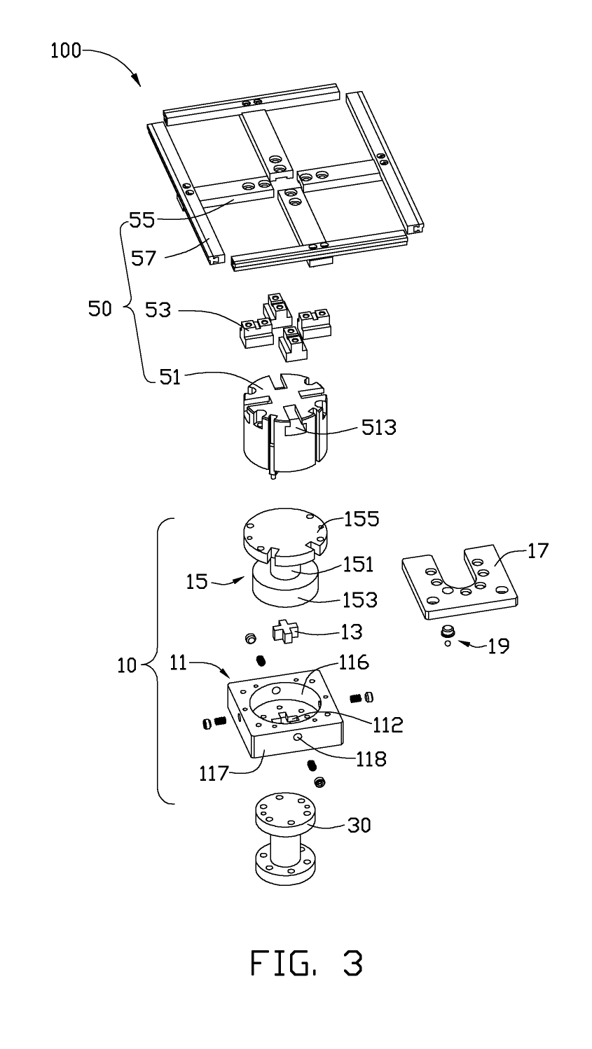

Also referring to FIGS. 2 and 3, the flexible adjusting mechanism 10 includes a flexible adjusting base 11, a sliding block 13, a sliding shaft 15, an adjustment assembly 16, a fixing member 17 and a lubricating assembly 19. The flexible adjusting base 11 is a substantially rectangular board in the illustrated embodiment, and includes a top surface 111, a bottom surface 115 opposite to the top surface 111, and four side surfaces 117. A substantially cross-shaped mounting slot 112 is defined through the top surface of the flexible adjusting base 11. The mounting slot 112 includes a first mounting slot 1121 and a second mounting slot 1122 perpendicularly intersecting with the first mounting slot 1121. The first mounting slot 1121 has a length greater than that of the second mounting slot 1122, but has a width less than that of the second mounting slot 1122. A receiving chamber 116 is recessed from the bottom surface 115 of the flexible adjusting base 11 and communicates with the mounting slot 112. In one embodiment, the receiving chamber 116 is substantially hollow cylindrical and is positioned at the substantially central portion of the bottom surface 115. Each side surface 117 defines an assembly hole 118 communicating with the receiving chamber 116.

The sliding block 13 is slidably assembled within the mounting slot 112, and further slidably assembled with the sliding shaft 15. In the illustrated embodiment, the sliding block 13 is substantially cross-shaped, and is slidably assembled within the mounting slot 112 along a preset direction. The sliding block 13 includes a first sliding block 131 and a second sliding block 132 perpendicularly intersecting with the first sliding block 131. The first sliding block 131 has a shape and dimension substantially the same as that of the second sliding block 132. The first and second sliding blocks 131, 132 both have a width substantially the same as that of the first mounting slot 1121, but less than that of the second mounting slot 1122. The first and second sliding blocks 131, 132 both have a length less that of the first mounting slot 1121, but greater than that of the second mounting slot 1122. One end of the sliding block 13 is slidably assembled within the mounting slot 112 of the flexible adjusting base 11, and the opposite other end of the sliding block 13 is received within the receiving chamber 116 of the flexible adjusting base 11, and further slidably assembled with the sliding shaft 15.

The sliding shaft 15 includes a main shaft 151, a connecting shaft 153 coaxially extending from a first end of the main shaft 151, and a fixed shaft 155 coaxially extending from a second end of the main shaft 151 opposite to the first end thereof. The connecting shaft 153 and the fixed shaft 155 both have a diameter greater than that of the main shaft 151. The connecting shaft 153 is substantially cylindrical disk-shaped, and is slidably mounted to and received within the receiving chamber 116 of the flexible adjusting base 11, and further slidably mounted with the sliding block 13. An assembly slot 154 is defined in the distal end surface of the connecting shaft 153 corresponding to the sliding block 13. In the illustrated embodiment, the assembly slot 154 is a cross-shaped slot. The assembly slot 154 includes a first assembly slot 1541 and a second assembly slot 1542 perpendicularly intersecting with the first assembly slot 1541, and is respectively corresponding to the first and second sliding blocks 131, 132. The first assembly slot 1541 has a length substantially the same as that of the first sliding block 131, and has a width wider than that of the first sliding block 131. The second assembly slot 1542 has a length longer than that of the second sliding block 132, and has a width substantially the same as that of the second sliding block 132. Such that, when the sliding block 13 is assembled with the flexible adjusting base 11 and the sliding shaft 15, the flexible adjusting base 11 and the sliding shaft 15 are slidably assembled together along two perpendicular directions relative to each other.

The adjustment assembly 16 is adjustably mounted to the flexible adjusting base 11, for timely adjustment of an assembling tightness between the sliding shaft 15 and the flexible adjusting base 11, and buffering an impulse force suffered by the sliding shaft 15. In the illustrated embodiment, the adjustment assembly 16 includes four adjusting bolts 161 and four elastic members 163. The four adjusting bolts 161 together with the corresponding elastic members 163 are respectively screwed into the four assembly holes 118 of the four side surfaces 117 of the flexible adjusting base 11 and elastically resist against the periphery of the connecting shaft 153 of the sliding shaft 15. The elastic member 163 can be a coil spring, or an elastic washer.

The fixing member 17 is substantially U-shaped, and is sleeved on the main shaft 151 of the sliding shaft 15, and further securely mounted onto the bottom surface 115 of the flexible adjusting base 11. The fixing member 17 defines a U-shaped opening 171 and a plurality of mounting holes 173 surrounding the opening 171.

The lubricating assembly 19 includes a plurality of idle wheels 191 and a plurality of roller balls 193. The plurality of idle wheels 191 together with the corresponding plurality of roller balls 193 are respectively assembled within the corresponding plurality of mounting holes 173 of the fixing member 17, and resist against the connecting shaft 153 of the sliding shaft 15.

The gripping jaw assembly 50 is mounted to the fixed shaft 155 of the sliding shaft 15, for gripping the workpiece. The gripping jaw assembly 50 includes a cylindrical section 51, four connecting blocks 53, four gripping jaws 55 and four support rods 57. In the illustrated embodiment, the cylindrical section 51 is a cylindrical structure comprising four jaws, and is fixed to the fixed shaft 155 of the sliding shaft 15. The cylindrical section 51 is substantially cylindrical and defines four connecting slots 513 symmetrically at a periphery of the distal end of the cylindrical section 51. A cross section of each connecting slot 513 is substantially T-shaped. The four connecting blocks 53 are all substantially T-shaped, and are respectively assembled within the four connecting slots 513 of the cylindrical section 51. The four gripping jaws 55 are assembled to the cylindrical section 51 by the four connecting blocks 53, and are driven by the cylindrical section 51 to grip and release the workpiece. Each gripping jaw 55 is substantially rectangular bar-shaped; one end of each gripping jaw 55 is fixed with the connecting block 53. The four support rods 57 are respectively fixed to the other end of the four gripping jaws 55, and together form a substantially rectangular shape. The four support rods 57 are made of rubber or flexible plastic.

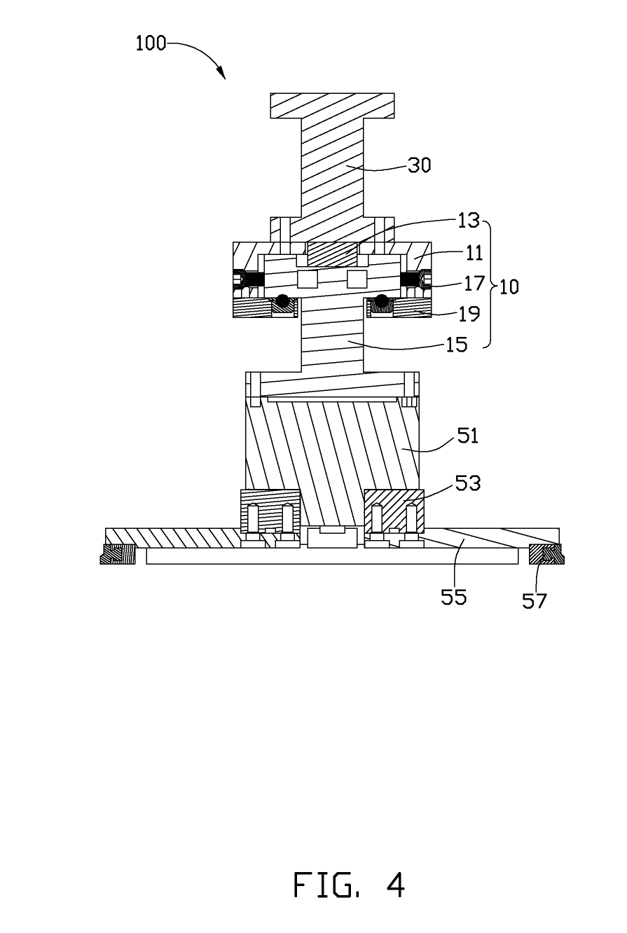

Also referring to FIGS. 2 through 4, when assembling the flexible adjustable gripping device 100, one end of the connecting member 30 is fixed to the top surface 111 of the flexible adjusting base 11, and is covered on the mounting slot 112. One end of the sliding block 13 is aligned with and is slidably assembled within the mounting slot 112 of the flexible adjusting base 11. The other end of the sliding block 13 is received within the receiving chamber 116 of the flexible adjusting base 11. The first and second sliding blocks 131, 132 are respectively received within the first and second mounting slots 1121, 1122 of the mounting slot 112. The connecting shaft 153 of the sliding shaft 15 is inserted into the receiving chamber 116 of the flexible adjusting base 11, and is slidably assembled with the other end of the sliding block 13. The other end of the sliding block 13 is correspondingly slidably assembled into the assembly slot 154 of the connecting shaft 153. The four adjusting bolts 161 together with the corresponding elastic members 163 of the adjustment assembly 16 are respectively screwed into the four assembly holes 118 of the four side surfaces 117 of the flexible adjusting base 11 and elastically resist against the periphery of the connecting shaft 153 of the sliding shaft 15. The fixing member 17 is sleeved on the main shaft 151 of the sliding shaft 15, and is securely mounted onto the bottom surface 115 of the flexible adjusting base 11. The lubricating assembly 19 is assembled to the fixing member 17. The roller balls 193 resist against the connecting shaft 153 of the sliding shaft 15. The gripping jaw assembly 50 is finally mounted to the fixed shaft 155 of the sliding shaft 15 to finish the assembly of the flexible adjustable gripping device 100.

In use, the connecting member 30 is connected to a mechanical arm or a driving shaft of a robot (not shown), and is driven by the mechanical arm or the driving shaft of the robot to move adjacent to the pre-gripped workpiece. The four gripping jaws 55 together with the four support rods 57 are driven by the cylindrical section 51 to align with and grip the workpiece, meanwhile, the gripping jaw assembly 50 together with the sliding shaft 15 can slide slightly relative to the flexible adjusting base 11 for ensuring the gripping accuracy of the flexible adjustable gripping device 100. In addition, the adjustment assembly 16 together with the lubricating assembly 19 can efficiently absorb and decrease the impulse force suffered by the sliding shaft 15 in use.

It is to be understood, however, that even through numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A flexible adjustable gripping device, comprising:
a flexible adjusting mechanism comprising:
a flexible adjusting base defining a mounting slot;
a sliding shaft; and
a sliding block slidably assembled within the mounting slot, and further slidably connected with the sliding shaft; and
a gripping jaw assembly fixed to the sliding shaft.

2. The flexible adjustable gripping device as claimed in claim 1, wherein the flexible adjusting mechanism further comprises an adjustment assembly adjustably mounted to the flexible adjusting base and elastically resisting against the sliding shaft, for timely adjusting an assembling tightness between the sliding shaft and the flexible adjusting base, and buffering an impulse force suffered by the sliding shaft.

3. The flexible adjustable gripping device as claimed in claim 2, wherein the flexible adjusting base comprises a top surface, a bottom surface opposite to the top surface, and four side surfaces, the mounting slot is substantially cross-shaped and defined through the top surface of the flexible adjusting base; the sliding block is substantially cross-shaped, and is slidably assembled within the mounting slot along one preset direction.

4. The flexible adjustable gripping device as claimed in claim 3, wherein the mounting slot comprises a first mounting slot and a second mounting slot perpendicularly intersecting with the first mounting slot; the first mounting slot has a length greater than that of the second mounting slot, but has a width less than that of the second mounting slot; the sliding block includes a first sliding block and a second sliding block perpendicularly intersecting with the first sliding block; the first sliding block has a shape and dimension substantially the same as that of the second sliding block; the first and second sliding blocks both have a width substantially the same as that of the first mounting slot, but less than that of the second mounting slot; the first and second sliding blocks both have a length less that of the first mounting slot, but larger than that of the second mounting slot.

5. The flexible adjustable gripping device as claimed in claim 3, wherein the flexible adjusting base further comprises a receiving chamber recessed from the bottom surface thereof and communicating with the mounting slot; a first end of the sliding block is slidably assembled within the mounting slot of the flexible adjusting base, a second end of the sliding block opposite to the first end is received within the receiving chamber, and further slidably assembled with the sliding shaft.

6. The flexible adjustable gripping device as claimed in claim 5, wherein each of the four side surfaces of the flexible adjusting base defines an assembly hole communicating with the receiving chamber; the adjustment assembly comprises four adjusting bolts and four elastic members, the four adjusting bolts together with the corresponding four elastic members are respectively screwed into the four assembly holes of the flexible adjusting base and elastically resist against the periphery of the sliding shaft.

7. The flexible adjustable gripping device as claimed in claim 6, wherein the sliding shaft comprises a main shaft, a connecting shaft coaxially extending from one end of the main shaft, and a fixed shaft coaxially extending from the opposite other end of the main shaft; the connecting shaft is slidably mounted to and received within the receiving chamber of the flexible adjusting base; a cross-shaped assembly slot is defined in the distal end surface of the connecting shaft and slidably engages with the other end of the sliding block; the gripping jaw assembly is mounted to the fixed shaft of the sliding shaft.

8. The flexible adjustable gripping device as claimed in claim 7, wherein the gripping jaw assembly comprises a cylindrical section, four connecting blocks, and four gripping jaws; the cylindrical section is fixed to the fixed shaft of the sliding shaft; the four gripping jaws are assembled to and driven by the cylindrical section by the four connecting blocks.

9. The flexible adjustable gripping device as claimed in claim 7, wherein the assembly slot comprises a first assembly slot and a second assembly slot perpendicularly intersecting with the first assembly slot, and respectively corresponding to the first and second sliding blocks; the first assembly slot has a length substantially the same as that of the first sliding block, and has a width greater than that of the first sliding block; the second assembly slot has a length longer than that of the second sliding block, and has a width substantially the same as that of the second sliding block.

10. The flexible adjustable gripping device as claimed in claim 7, wherein the flexible adjusting mechanism further comprises a fixing member sleeved on the main shaft of the sliding shaft, and further securely mounted onto the bottom surface of the flexible adjusting base.

11. The flexible adjustable gripping device as claimed in claim 10, wherein the fixing member defines a U-shaped opening and a plurality of mounting holes surrounding the opening; the flexible mechanism further comprises a lubricating assembly assembled within the mounting holes of the fixing member, and resisting against the connecting shaft of the sliding shaft.

12. A flexible adjustable gripping device, comprising:
a flexible adjusting mechanism comprising:
a flexible adjusting base defining a mounting slot;
a sliding shaft; and
a sliding block slidably assembled within the mounting slot, and further slidably connected with one end of the sliding shaft; and
a gripping jaw assembly comprising:
a cylindrical section fixed to the other end of the sliding shaft;
four connecting blocks; and
four gripping jaws assembled to and driven by the cylindrical section by the four connecting blocks.

13. The flexible adjustable gripping device as claimed in claim 12, wherein the flexible adjusting base comprises a top surface, a bottom surface opposite to the top surface, and four side surfaces, the mounting slot is defined through the top surface of the flexible adjusting base; the sliding shaft comprises a main shaft, a connecting shaft coaxially extending from one end of the main shaft, and an assembly slot defined in the distal end surface of the connecting shaft; two ends of the sliding block are slidably assembled into the mounting slot of the flexible adjusting base and the assembly slot of the sliding shaft, respectively.

14. The flexible adjustable gripping device as claimed in claim 13, wherein the sliding shaft further comprises a fixed shaft coaxially extending from the opposite other end of the main shaft; the cylindrical section of the gripping jaw assembly is mounted to the fixed shaft of the sliding shaft.

15. The flexible adjustable gripping device as claimed in claim 14, wherein the flexible adjusting base further comprises a receiving chamber recessed from the bottom surface thereof and communicating with the mounting slot; the other end of the sliding block is received within the receiving chamber together with the connecting shaft of the sliding shaft.

16. The flexible adjustable gripping device as claimed in claim 15, wherein the flexible adjusting mechanism further comprises an adjustment assembly adjustably mounted to the flexible adjusting base and elastically resisting against the sliding shaft.

17. The flexible adjustable gripping device as claimed in claim 15, wherein the flexible adjusting mechanism further comprises a fixing member sleeved on the main shaft of the sliding shaft, and further securely mounted onto the bottom surface of the flexible adjusting base.

18. The flexible adjustable gripping device as claimed in claim 17, wherein the fixing member defines a U-shaped opening and a plurality of mounting holes surrounding the opening; the flexible adjusting mechanism further comprises a lubricating assembly assembled within the mounting holes of the fixing member, and resisting against the connecting shaft of the sliding shaft.
